(19) United States
(12) Patent Application Publication
(10) Pub. No.: US 2009/0260504 A1
(43) Pub. Date: Oct. 22, 2009

(54) AUTOMATIC AUDIO PLAYING DEVICE

(76) Inventor: WEI-KUO CHEN, Hsinchu City (TW)

Correspondence Address: LEONG C LEI, PMB # 1008, 1867 YGNACIO VALLEY ROAD, WALNUT CREEK, CA, 94598, US

(21) Appl. No.: 12/103,716

(22) Filed: Apr. 16, 2008

(51) Int. Cl. G10H 1/00

(52) U.S. Cl. 84/600

(57) ABSTRACT

The automatic audio playing device mainly contains a hollow body member, a control unit housed inside the body member, a plug member and a speaker as integral parts of the body member, an adaptor, and a remote controller. The control unit has a radio reception circuit for receiving control signals from the remote controller. The control signal is forwarded to a signal processing circuit, which in turn triggers a microprocessor in accordance with the control signals. The microprocessor instructs an audio playing circuit to play an appropriate digital audio file via the speaker. The plug member could be plugged into a conventional lamp socket for a light bulb, or the plug member is first plugged into the adaptor and the adaptor is then plugged into a conventional wall socket. Once this is done, the automatic audio playing device could be turned on and off by switches of existing wiring.

### (a) TECHNICAL FIELD OF THE INVENTION

The present invention generally relates to audio playing devices, and more particularly to an audio playing device that is turned on or off by existing wiring to start or stop playing digital audio files automatically.

### (b) DESCRIPTION OF THE PRIOR ART

To most people, music is an indispensable part of their daily lives. Portable music playing devices such as MP3 players or mobile phones capable of MP3 music playing are therefore widely popular.

On the other hand, indoor music playing devices such as CD players or stereos are usually positioned in a single room and the played music is only audible in that room. Sometimes, people would have speakers installed in various rooms and connected to a music source so that the played music is audible in these rooms. As can be imagined, the installation and wiring of the speakers are not easy tasks and, most of the time, are permanent once installed. In addition, the speakers are usually turned on or off altogether, which is quite inflexible.

Republic of China, Taiwan, Patent Publication Nos. 477,853 and 583,981 teach devices used in the toilet or bathroom that are capable of music playing. These devices are bulky, not easy to move freely, and designed to be used in a specific environment.

### SUMMARY OF THE INVENTION

The primary purpose of the present invention is to provide a novel and independent automatic device herein that utilizes existing wiring for turning on and off audio playing.

The automatic audio playing device mainly contains a hollow body member, a control unit housed inside the body member, a plug member and a speaker as integral parts of the body member, an adaptor, and a remote controller. The control unit has a radio reception circuit for receiving control signals from the remote controller. The control signal is forwarded to a signal processing circuit, which in turn triggers a microprocessor in accordance with the control signals. The microprocessor instructs an audio playing circuit to play an appropriate digital audio file via the speaker.

The plug member could be plugged into a conventional lamp socket for a light bulb, or the plug member is first plugged into the adaptor and the adaptor is then plugged into a conventional wall socket. Once this is done, the automatic audio playing device could be turned on and off by switches of existing wiring.

The control unit could have an input connector (e.g., an USB connector) for loading digital audio files into a non-volatile storage of the control unit.

The control unit could have a power detection circuit monitoring the electricity drawn by the automatic audio playing device. Therefore, for example, a fast turning on and off the power to the automatic audio playing device in a short while could be interpreted by the power detection circuit as, for example, “skip to the next song.”

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing an automatic audio playing device according an embodiment of the present invention.

FIG. 2 is a sectional diagram showing the automatic audio playing device of FIG. 1.

FIG. 3 is a perspective diagram showing the automatic audio playing device of FIG. 1 from another viewing angle.

FIG. 4 is a perspective diagram showing the control unit housed inside the automatic audio playing device of FIG. 1.

FIG. 5 is a functional block diagram showing the automatic audio playing device of FIG. 1.

FIGS. 6 and 7 show an application scenario of the automatic audio playing device of FIG. 1.

FIG. 8 is a flow diagram showing an audio playing operation of the automatic audio playing device of the present invention when power is turned on and off.

FIG. 9 shows another application scenario of the automatic audio playing device of FIG. 1.

FIG. 10 shows an automatic audio playing device of the present invention integrated with a lamp and plugged into a power extension cable.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

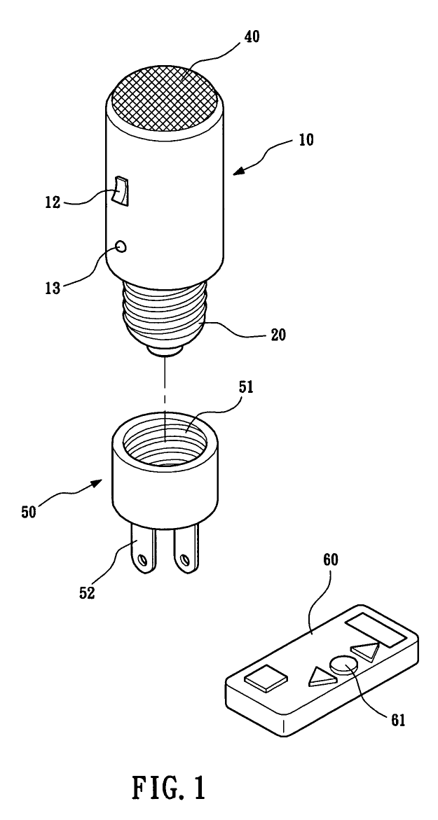

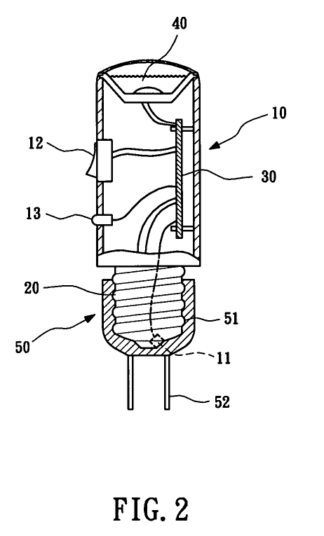

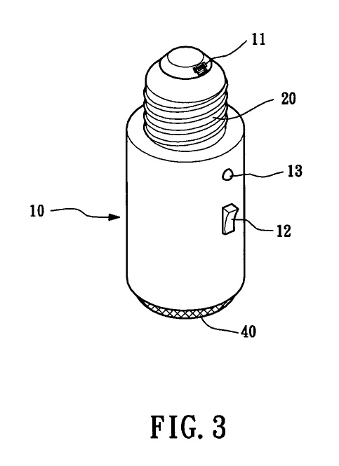

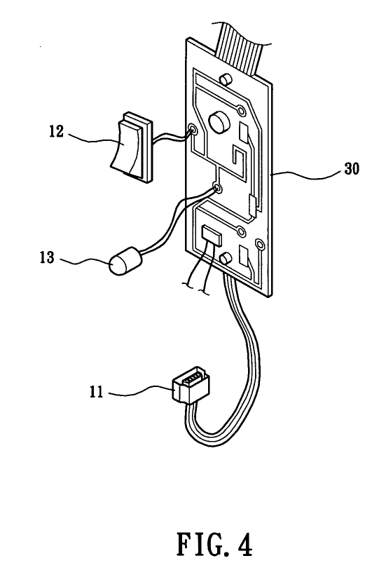

As shown in FIGS. 1 to 4, an automatic audio playing device according to an embodiment of the present invention mainly contains a hollow body member 10, a plug member 20, a control unit 30, a speaker 40, an adaptor 50, and a remote controller 60.

The control unit 30 is housed inside the body member 10 while the speaker 40 and the plug member 20 are integral parts and exposed from an external surface of the body member 10.

To use the automatic audio playing device, its plug member 20 is plugged into a conventional lamp socket for a light bulb, or its plug member 20 is first plugged into the adaptor 50 and the adaptor 50 is then plugged into a conventional wall socket. Once this is done, the automatic audio playing device could be turned on and off by power switches of existing wiring, and the remote controller 60 could be used to control the volume, select a song, or pause the playing of the automatic audio playing device. As such, at any place with a lamp socket or a wall socket, the automatic audio playing device could be conveniently installed and operated by a novice user to enjoy music.

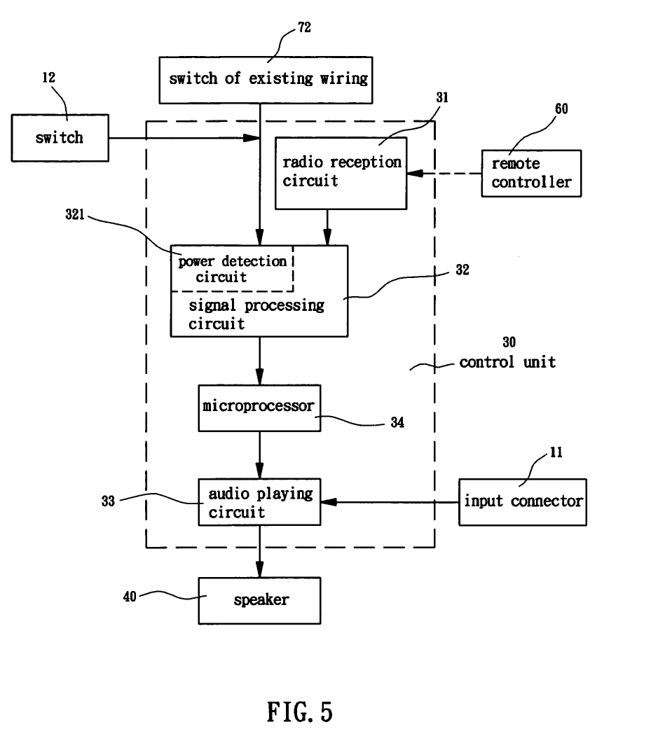

As shown in FIG. 5, the control unit 30 is connected with a switch 12 for manually turning on and off the automatic audio playing device (usually is set to ON), an indicator lamp 13 for showing an operation status of the automatic audio playing device (e.g., whether it is turned on), and an input connector 11 (e.g., an USB connector) for loading digital audio files (e.g., in MP3 or WMA format) onto the control unit 30 (more details will be given later). The switch 12 and the indicator lamp 13 are exposed on an external surface of the body member 10. In the present embodiment, the input connector 11 is exposed on an external surface of the plug member 20.

The plug member 20, as in the present embodiment, could have a conventional plug such as the one found on a light bulb so that it could be twisted on a conventional lamp socket. In alternative embodiments, the plug member 20 could have a conventional plug with two or more prongs such as one found on a power cable. As such, the automatic audio playing device could be directly plugged into a wall socket or a socket on a power extension cable.

The adaptor 50 has a socket 51 compatible to the plug member 20 so that the adaptor 50 could be detachably joined to the plug member 20. The adaptor 50 then has another type of plug such as two prongs 52 as illustrated so that the automatic audio playing device along with the adaptor 50 could be plugged into a wall socket or a socket on a power extension cable.

The control unit 30 has a radio reception circuit 31 for receiving control signals sent to the automatic audio playing device from the remote controller 60. The control signals received by the radio reception circuit 31 are forwarded to a signal processing circuit 32, which in turn triggers a microprocessor 34 in accordance with the control signals. The signal processing circuit 32 could have a power detection circuit 321 monitoring the electricity drawn by the automatic audio playing device 60. Therefore, for example, a fast turning on and off the power to the automatic audio playing device in a short while could be interpreted by the power detection circuit 321 as, for example, “skip to the next song” and a corresponding signal is therefore sent to the microprocessor 34. The microprocessor 34 is the brain of the automatic audio playing device that, based on the triggers it receives from the signal processing circuit 32, the microprocessor 34 instructs an audio playing circuit 33 to, for example, play an appropriate digital audio file. The audio playing circuit 33 contains a non-volatile storage (not shown) which could contain some built-in digital audio files. Additional digital audio files (e.g., songs encoded in MP3 format) could be loaded into the storage through the input connector 11.

The audio playing circuit 33 produces analog electrical signals in accordance with the digital audio file being played and the electrical signals are transformed by the speaker 40 into audible sounds.

The remote controller 60 has a number control buttons 61 that interact with an internal circuit board to send out various radio control signals to the radio reception circuit 31.

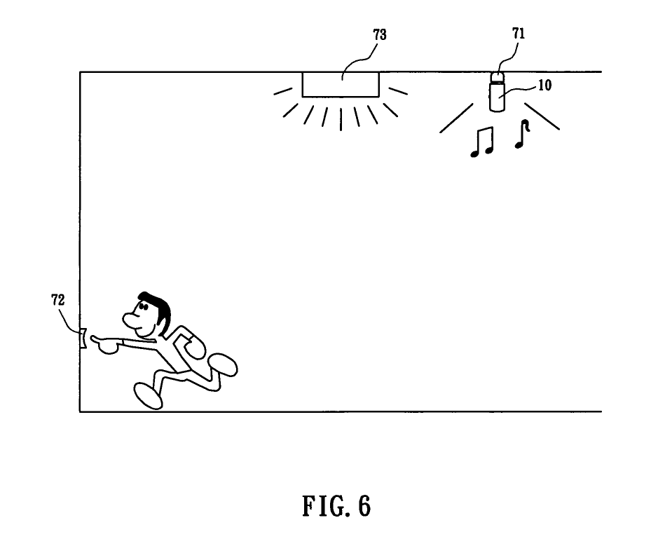

FIGS. 6 and 7 show an application scenario of the automatic audio playing device of the present invention. As illustrated, a room has existing wiring that allows a switch 72 to tuning on and off a ceiling lamp 73 and a lamp socket 71. By installing the automatic audio playing device in the lamp socket 71, the automatic audio playing device could be automatically turned on and off when the switch 72 is turned on and off. When the automatic audio playing device is turned on or off, the microprocessor 34 automatically instructs the audio playing circuit 33 to start or stop playing a digital audio file. When the automatic audio playing device is turned on, the remote controller 60 could be used to control the automatic audio playing device such as to skip to the next song, increase or decrease the volume of the speaker, etc. Therefore, without troublesome installation of new speakers and wiring, the automatic audio playing device of the present invention allows users to easily enjoy music in every room utilizing existing wiring.

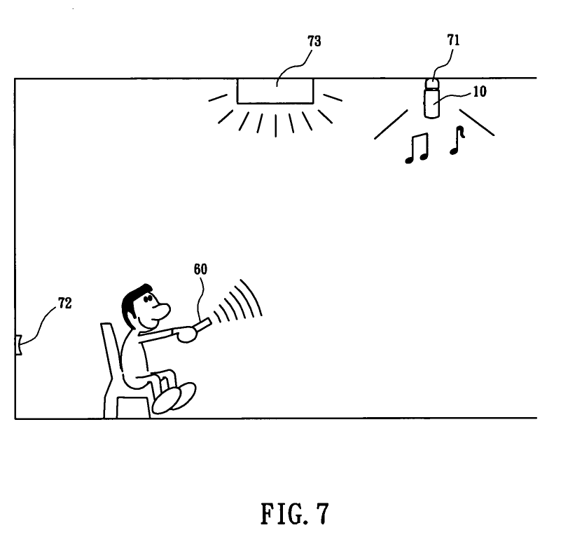

As shown in FIG. 8, when the automatic audio playing device is first turned on, a first digital audio file in the storage is played. If the automatic audio playing device remains turned on, the automatic audio playing device would play the digital audio files in its storage sequentially. On the other hand, if the automatic audio playing device is quickly turned off and on again within a short while, the power detection circuit 321 mentioned earlier would sense this condition and signals the microprocessor 34 to, for example, skip to the next digital audio file in its storage.

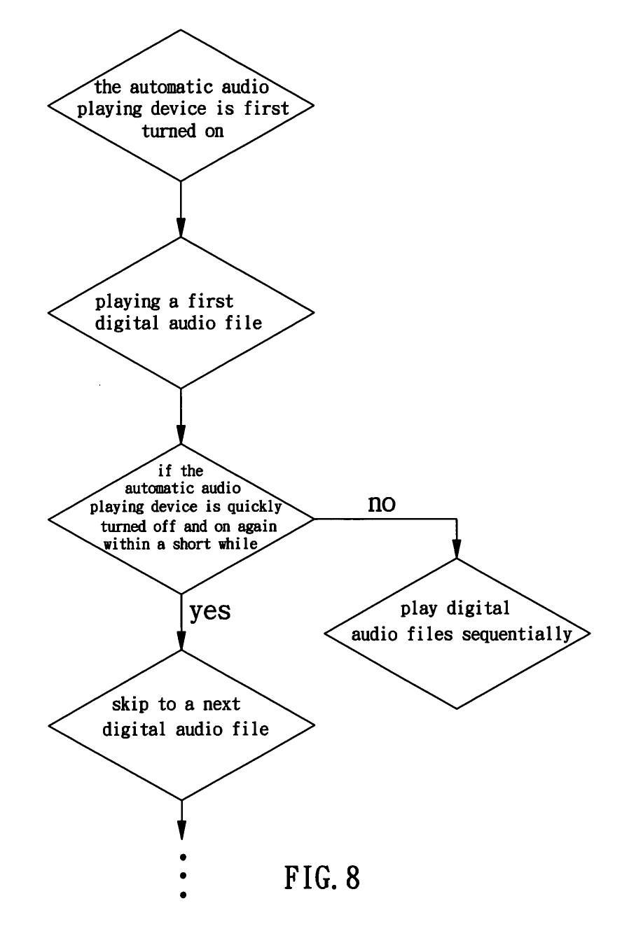

FIG. 9 shows another application scenario of the present invention where the automatic audio playing device is twisted on the adaptor 50 and then plugged into a wall socket 81.

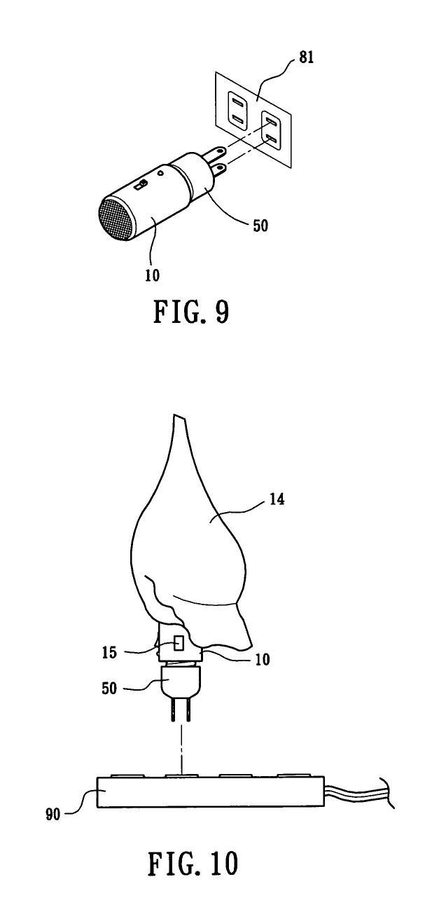

FIG. 10 shows another embodiment of the present invention where the automatic audio playing device is integrated with a lamp 14 (e.g., a night lamp) and the body member 10 has an additional switch 15 for turning on and off the lamp 14. In the diagram, the integrated lamp and automatic audio playing device is twisted on the adaptor 50 and then together plugged into a socket of a power extension cable 90.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An automatic audio playing device, comprising:
a hollow body member;
a speaker and a plug member, both being integral parts of said body member, said plug member capable of establishing electrical contact with an external power source;
a remote controller; and
a control unit housed inside said body member, said control unit having a radio reception circuit for receiving control signals from said remote controller, and an audio playing circuit with a non-volatile storage capable of storing at least a digital audio file;
wherein, when electricity of said external power source to said automatic audio playing device via said plug member is conducted or disrupted, said audio playing circuit starts or stops playing a digital audio file of said storage through said speaker into audible sounds.

2. The automatic audio playing device according to claim 1, wherein said control unit further has an input connector for loading a digital audio file into said storage of said audio playing circuit.

3. The automatic audio playing device according to claim 1, wherein said control unit further has a switch exposed on an external surface of said body member for manually turning on and off said automatic audio playing device.

4. The automatic audio playing device according to claim 1, wherein said plug member is capable of being plugged into a conventional lamp socket.

5. The automatic audio playing device according to claim 1, wherein said plug member is capable of being plugged into a wall socket of a socket of a power extension cable.

6. The automatic audio playing device according to claim 1, wherein said control unit further has a power detection circuit detecting quick disruption and conduction of electricity in a short while and producing a control signal to said control unit.

7. The automatic audio playing device according to claim 1, further comprising an adaptor, wherein said adaptor is capable of joining to said plug member.

8. The automatic audio playing device according to claim 7, wherein said adaptor is capable of being plugged into a wall socket of a socket of a power extension cable.

9. The automatic audio playing device according to claim 1, wherein said automatic audio playing device is integrated with a lamp.

10. The automatic audio playing device according to claim 1, wherein said digital audio file is in one of MP3 format and WMA format.
